(19) United States
(12) Patent Application Publication
(10) Pub. No.: US 2020/0013050 A1
(43) Pub. Date: Jan. 9, 2020

(54) BLOCKCHAIN BASED PAYMENTS FOR DIGITAL CERTIFICATE PROVISIONING OF INTERNET OF THINGS DEVICES

(71) Applicants: Keir Finlow-Bates, Kangasala (FI); Jonathan Sean Callan, Cambridge (GB)

(72) Inventors: Keir Finlow-Bates, Kangasala (FI); Jonathan Sean Callan, Cambridge (GB)

(21) Appl. No.: 16/029,226

(22) Filed: Jul. 6, 2018

(51) Int. Cl. G06Q 20/38; G06Q 20/40

(52) U.S. Cl. CPC G06Q 20/382; G06Q 20/401; G06Q 20/3825

(57) ABSTRACT

A system and method for associating payment with provisioning an IoT device with a digital certificate without a need for a central Certificate Authority is presented. The IoT device is preloaded with a nonce, and a hash of the nonce signed by an authorized certificate is published on the blockchain. The nonce may then be submitted to the blockchain with a self-signed certificate, the presence of the nonce validating the self-signed certificate. The blockchain provides a final single view of a true state of the digital certificates in the system and their respective authority and validity. The publishing and signing of certificates may be associated with a transfer of tokens, or digital credits of commercial value.

### TECHNICAL FIELD

This disclosure relates to computer systems and methods concerned with associating payments with a provisioning of Internet of Things (IoT) devices with digital certificates, and more specifically to systems and methods for distributed and decentralized payments during the provisioning using a blockchain.

### BACKGROUND

Distributed ledgers or blockchains provided in, for example, a peer-to-peer network, such as the distributed ledger used in the Bitcoin™ cryptocurrency system, allow participants on the peer-to-peer network to participate in a sharing of data in a distributed manner without a need for a central authority. As such, blockchains are well suited for tracking payment balances.

A public key infrastructure (PKI) may rely on digital certificates in order to identify parties operating in a system, and to enable encrypted secure communication between parties. For example, digital certificates are used to identify web sites, and to enable clients to connect and download web pages over a secure connection, using secure sockets layer (SSL) or transport layer security (TLS) cryptographic protocols.

In order to trust the digital certificates, an authorized certificate may sign other certificates, providing the other certificates with validity. A PKI thus relies on a trust in the authorized certificate.

In a centralized system an issue of establishing the trust is overcome by faith in a central authority, which owns the the authorized certificate, also known as a root certificate. Policies and processes used by a provider to decide which certificate authorities client software should trust are called root programs. The central authority may charge a fee for services it provides.

However, a centralized system and centralized root program have a number of problems. The central authority may have the ability to arbitrarily issue and revoke certificates without oversight. Furthermore, central authorities are able to set their own pricing for their services, oft times resulting in higher costs for users of the centralized system.

IoT devices may comprise lightweight devices in terms of memory and power consumption, with limitations on network connectivity. A current solution is to generate certificates for each IoT device in a chip factory and pre-load the certificate onto an IoT device. As time and effort are at a premium in the chip factory, an improvement to the current solution by reducing an amount of data to load onto the IoT device, and a number of computations that may be performed to generate the certificate is desirable.

It is therefore the intention of the present disclosure to address the problem of enabling payments for services related to a public key infrastructure and certificate distribution to IoT devices in a cost-efficient decentralized fashion without recourse to a central authority.

### SUMMARY

In accordance with the present disclosure, a solution is provided for enabling payment for distributing valid certificates to IoT devices through a medium of a blockchain.

An example embodiment may include a method for enabling a payment for provisioning a device with a digital certificate, comprising: loading a nonce onto the device, publishing a message on a blockchain, comprising a hash of the nonce signed by an authorized digital certificate, and publishing a second message on the blockchain, comprising: the digital certificate, the nonce, and a token transaction.

In the example embodiment, the token transaction may comprise one or more of: an offering of a token, and a claim of the token. The offering of the token may be embodied as a published script or signed transaction stipulating conditions under which the token may be redeemed. In this embodiment the token may be transferred if the conditions of the published script or signed transaction are met. The claim of the token may be embodied as a further published script meeting the conditions of the offering of the token, and the further published script may thus claim the token.

In the example embodiment, the message may comprise an offering of a token, and the token transaction may comprise a claim of the token.

In an alternate embodiment of the example embodiment, the token transaction may comprise an offering of a token. In the alternate embodiment, the offering of the token may be redeemed by publishing a third message on the blockchain, said third message comprising: a signature of the digital certificate generated using the authorized digital certificate, and a second token transaction comprising a claim of the token.

In the example embodiment, the device may comprise an Internet of Things (IoT) compatible device.

In the example embodiment the device may be further configured to publish messages on the blockchain via an intermediary. The intermediary may comprise a blockchain node, a Constrained Application Protocol (CoAP) server, a Message Queuing Telemetry Transport (MQTT) server, or an other server configured to accept connections from the device and forward them on to the blockchain.

In the example embodiment, the token transaction may be stored and executed using a smart contract on the blockchain.

In the alternate embodiment, one or more of the token transaction and the second token transaction may be stored and executed using a smart contract on the blockchain.

An other example embodiment may include an apparatus enabling a payment for provisioning a device with a digital certificate, comprising a processor configured to load a nonce onto the device, and publish a message comprising a hash of the nonce signed by an authorized digital certificate on a blockchain. The device may publish a second message comprising the digital certificate, the nonce, and a token transaction. The token transaction may comprise one or more of: an offering of a token, a claim of a token.

In the other example embodiment, the message may comprise an offering of a token, and the token transaction may comprise a claim of the token.

In the other example embodiment, the offering of the token may be embodied as a published script or signed transaction stipulating conditions under which the token may be redeemed. The token may be transferred if the conditions of the published script or signed transaction are met. The claim of the token may be embodied as a further published script meeting the conditions of the offering of the token, and the further published script may thus claim the token.

In an other alternate embodiment of the example embodiment, the token transaction may comprise an offering of a token, and the processor may be configured to publish, on the blockchain, a third message comprising: a signature of the digital certificate generated using the authorized digital certificate, and a second token transaction comprising a claim of the token.

In the other example embodiment, the device may comprise an Internet of Things (IoT) compatible device.

In the other example embodiment the device may be further configured to publish messages on the blockchain via an intermediary. The intermediary may comprise a blockchain node, a Constrained Application Protocol (CoAP) server, a Message Queuing Telemetry Transport (MQTT) server, or an other server configured to accept connections from the device and forward them on to the blockchain.

In the other example embodiment, the token transaction may be stored and executed using a smart contract on the blockchain.

In the other alternate embodiment, one or more of the token transaction and the second token transaction may be stored and executed using a smart contract on the blockchain.

A yet other example embodiment may include a non-transitory computer readable medium embodying instructions for enabling payment for provisioning a device with a digital certificate, the instructions when executed causing a processor to load a nonce onto the device, and publish a message comprising a hash of the nonce signed by an authorized digital certificate on a blockchain. Subsequently the device may publish a second message comprising the digital certificate, the nonce, and a token transaction comprising one or more of an offering of a token, and a claim of a token, on a blockchain.

In the yet other example embodiment, the message may comprise an offering of a token, and the token transaction may comprise a claim of the token.

In the yet other example embodiment, the offering of the token may be embodied as a published script or signed transaction stipulating conditions under which the token may be redeemed. The token may be transferred if the conditions of the published script or signed transaction are met. The claim of the token may be embodied as a further published script meeting the conditions of the offering of the token, and the further published script may thus claim the token.

In a yet other alternate embodiment of the yet other example embodiment, the token transaction may comprise an offering of a token, and the processor may be configured by the instructions to perform a publishing, on the blockchain, of a third message comprising: a signature of the digital certificate generated using the authorized digital certificate, and a second token transaction comprising a claim of the token.

In the yet other example embodiment, the device may comprise an Internet of Things (IoT) compatible device.

In the yet other example embodiment the device may be configured to publish messages on the blockchain via an intermediary. The intermediary may comprise a blockchain node, a Constrained Application Protocol (CoAP) server, a Message Queuing Telemetry Transport (MQTT) server, or an other server configured to accept connections from the device and forward them on to the blockchain.

In the yet other example embodiment, the token transaction may be stored and executed using a smart contract on the blockchain.

In the yet other alternate embodiment, one or more of the token transaction and the second token transaction may be stored and executed using a smart contract on the blockchain.

In embodiments of the present disclosure, digital certificates may comprise a public key, and none or more of: a private key, a subject, an email address, a serial number, a thumb-print record, an other biometric record, an expiry date, a signature by an authorized digital certificate, a signature by a root certificate, a usage descriptor, a common name, a web site identifier, a device identifier, an organization name, an organizational unit, an issue date, a hash of a some or all of a remainder of a certificate data.

In other embodiments of the present disclosure, digital certificates may comprise an X.509 standard certificate, an OpenPGP certificate, a card verifiable certificate (CVC), or an other standard certificate format.

In some embodiments of the present disclosure, a token may comprise a plurality of tokens. In other embodiments a token may comprise a digital credit of commercial value, a cryptocurrency such as Bitcoin™, a utility token such as Ether, or an other unique unforgeable digital asset tracked and transferred using a distributed ledger or blockchain.

In some embodiments of the present disclosure, tokens may be instantiated and transferred using a smart contract. A smart contract may comprise computer code submitted to a blockchain, and run on one or more blockchain nodes in response to a submission of a token transaction to the blockchain.

In some embodiments of the present disclosure, a nonce may comprise a random number. In other embodiments the nonce may comprise an arbitrary number, used only once per device, to be used as as an initialization vector in a process of provisioning the device with a digital certificate. In yet other embodiments of the present disclosure, the nonce may be required to be non-repeating and unique.

In some embodiments of the present disclosure, a nonce may comprise a private key associated with a cryptocurrency address. The cryptocurrency address may be derived from a public key of a private/public key pair, said private/public key pair comprising the private key. The cryptocurrency address may have a cryptocurrency balance associated with it, said cryptocurrency balance recorded on a blockchain. In further embodiments of the present disclosure, token transactions associated with provisioning a device with a digital certificate may comprise transferring cryptocurrency from the cryptocurrency address to one or more other cryptocurrency addresses.

Those skilled in the art will further appreciate the advantages and superior features found in this disclosure together with other important aspects thereof on reading the detailed description that follows in conjunction with the drawings.

### BRIEF DESCRIPTION OF THE DRAWINGS

The components in the figures are not necessarily to scale, emphasis instead being placed upon illustrating the principles of the present disclosure. In the figures, like reference numerals designate corresponding parts throughout the different views.

FIG. 1 illustrates an apparatus configured to support one or more of the example embodiments.

FIG. 2 illustrates a device to be provisioned with a digital certificate.

FIG. 3 is a diagram illustrating loading a nonce onto a device and publishing a hash of the nonce and an associated offering of a token, on a blockchain.

FIG. 4 is an illustration of an apparatus for loading a nonce onto a device, and publishing a hash of the nonce and associated token transaction on a blockchain.

FIG. 5 is a flow diagram illustrating a process for a device to generate a digital certificate and validate said digital certificate on a blockchain, with an associated token transaction.

FIG. 6 is a diagram presenting an intermediary publishing an announcement of a digital certificate on behalf of an IoT device, and an associated token transaction.

FIG. 7 illustrates a structure for a message, published on a blockchain, said message verifying an announcement of a digital certificate and publishing a signature for the digital certificate, and an associated token transaction.

FIG. 8 is a flow diagram illustrating a third party verifying a validity of a digital certificate and associated token transaction presented by a device.

FIG. 9 is an illustration of a chain of digital certificates and authorization signatures on a blockchain with associated payment transactions.

FIG. 10 is a programmatic diagram illustrating a structure of a smart contract providing functions and methods related to digital certificate provisioning and associated payment transactions.

FIG. 11 is an illustration of a peer-to-peer network with a plurality of devices connected to the peer-to-peer network, in accordance with an embodiment of the present invention.

### DETAILED DESCRIPTION

Various aspects of this disclosure are now described with reference to the drawings. In a description that follows, specific details are provided to promote a thorough understanding of one or more aspects of the disclosure.

The present disclosure is directed to a method, apparatus, and system for provisioning a device with a digital certificate using blockchain technology, and for offering and redeeming tokens through token transactions associated with digital certificate provisioning.

Token transactions may comprise one or more of: an offering of tokens that may be redeemed under specified conditions, a redemption of offered tokens, a generation of new tokens, and a destruction of tokens.

A token may comprise one or more of: a cryptocurrency, a cryptocoin, a digital loyalty point, a digital credit, and a unique unforgeable digital asset. A token may be associated with a clear and unique ownership, and an ability to transfer said token from one entity to another entity through a distributed ledger such as a blockchain.

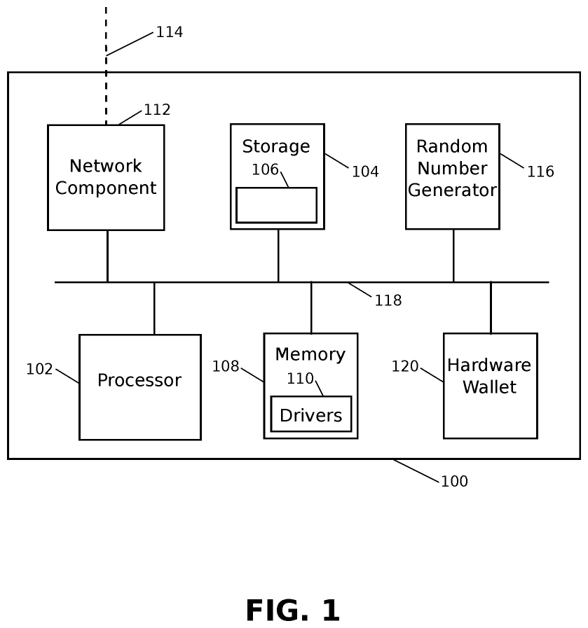

In FIG. 1, an embodiment of a device 100 supporting a provisioning of a digital certificate is presented.

In the embodiment, the device 100 may comprise a processor 102, comprising one or more central processing units (CPUs), capable of executing instructions stored in a memory 108, and controlling other peripheral components through drivers 110 stored within the memory.

Further storage 104 may be present, which may comprise a secure partition 106 or other component where cryptographic keys may be securely stored. Instructions may be retrieved from the storage 104 and transferred to the memory 108 as required.

The storage 104 may comprise a non-transitory computer readable medium storing instructions that may be executed by the processor 102.

The device 100 may comprise a network component 112, which may connect the device 100 to a network. The network component 112 may consist of a direct wired connection to a packet switched network through a cable 114. In other embodiments a connection to the network may be through wireless components comprising one or more wireless modules implemented in firmware or hardware, for example, a wireless local area network (WLAN) unit such as an adapter utilizing an 802.11 protocol, a wireless wide area network (WWAN) unit such as Global System for Mobile communications (GSM), Long Term Evolution (LTE), or other cellular wireless data communication system.

The device 100 may comprise a random number generator 116. In some embodiments the random number generator 116 may comprise a module to execute a pseudo-random number generating algorithm. In other embodiments the random number generator 116 may comprise a hardware random number generator, and may use a source of random information, such as a thermal noise generator, a nuclear decay radiation source, a photon transmitter and receiver, a homodyne detector, a spontaneous parametric down-conversion detector.

The device 100 may comprise a hardware wallet 120. The hardware wallet 120 may comprise components for storing cryptographic keys, generating cryptocurrency addresses, and producing or verifying cryptocurrency or token transactions.

Components comprising the device 100 may communicate through a bus 118, which may be implemented as a peripheral component interconnect express (PCIe) bus, a universal serial bus (USB), a universal asynchronous receiver/transmitter (UART) serial bus, a suitable advanced micro-controller bus architecture (AMBA) interface, a serial digital input output (SDIO) bus, or other equivalent interface.

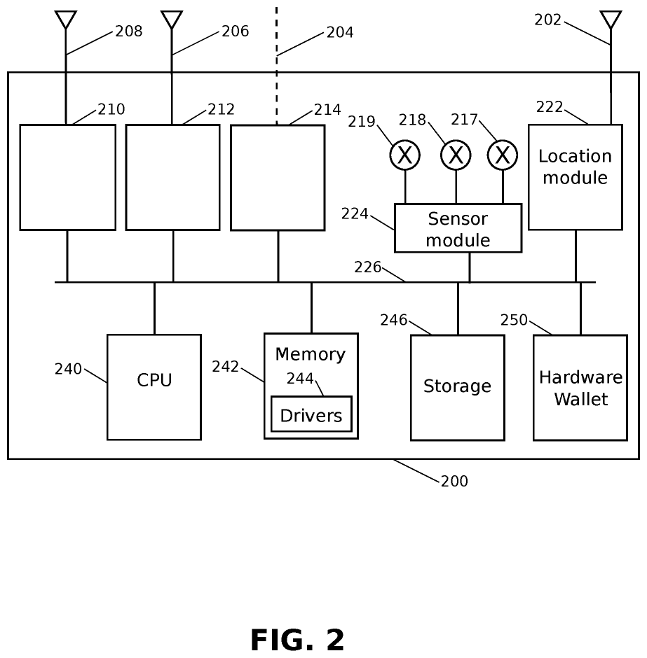

An embodiment of a device 200 to be provisioned with a digital certificate is presented in FIG. 2, and is now discussed in further detail. The device 200 may comprise one or more central processing units (CPU) 240 capable of executing instructions stored in a memory 242, and controlling other peripheral components through drivers 244 stored within the memory 242.

Further storage 246 may be present, which may comprise a secure partition or component where cryptographic keys may be securely stored.

The device 200 may comprise a network module 214, which may consist of a direct wired connection to a packet switched network through a cable 204.

The device 200 may comprise a wireless network module 212, which may comprise wireless components comprising one or more wireless modules implemented in firmware or hardware, including a wireless local area network (WLAN) unit such as a Wi-Fi adapter utilizing an 802.11 protocol, a wireless wide area network (WWAN) unit such as Global System for Mobile communications (GSM), Long Term Evolution (LTE), or other cellular wireless data communication system. The wireless network module may comprise an antenna 206. The wireless components may provide network connectivity to a packet switched network for the device 200.

The device 200 may comprise a personal area network module 210, which may comprise wireless components comprising one or more personal area network components implemented in firmware or hardware. The personal area network module 210 may comprise an antenna 208. The personal area network components may provide network connectivity to a packet switched network for the device 200.

In other embodiments the personal area network module 200 may comprise a Bluetooth™ component.

Components comprising the device 200 may communicate through a bus 226, which may be implemented as a peripheral component interconnect express (PCIe) bus, a universal serial bus (USB), a universal asynchronous receiver/transmitter (UART) serial bus, a suitable advanced micro-controller bus architecture (AMBA) interface, a serial digital input output (SDIO) bus, or other equivalent interface.

Optionally, the device 200 may also comprise an integrated location determining module 222, comprising one or more of: a time-of-flight positioning system, an inertial sensing positioning system, a spacial scanning positioning system, a phase differencing positioning system, a global navigation satellite system (GNSS) receiver, a real-time kinematic (RTK) module, a magnetic navigation module, and a hybrid positioning system.

In some embodiments the device 200 may comprise an antenna 202 for a GNSS receiver or an RTK module.

Optionally, the device 200 may also comprise a sensor module 224, connected to one or more sensors or MEMS devices 217, 218, 219. Such sensors may comprise one or more of: an altimeter, a magnetometer, a gyroscopic sensor, an accelerometer, a thermometer, a pressure gauge, a light sensor, a camera, a microphone, an odometer, an infrared sensor, an ultrasonic sensor, a gas sensor, a smoke sensor, an alcohol sensor, a proximity sensor, a humidity sensor, a moisture sensor, a tilt sensor, a force sensor, an electrical resistance meter, a voltage meter, an electrical current meter, and an other sensor type.

The device 200 may comprise a hardware wallet 250. The hardware wallet 250 may comprise components for storing cryptographic keys, generating cryptocurrency addresses, and producing or verifying cryptocurrency or token transactions.

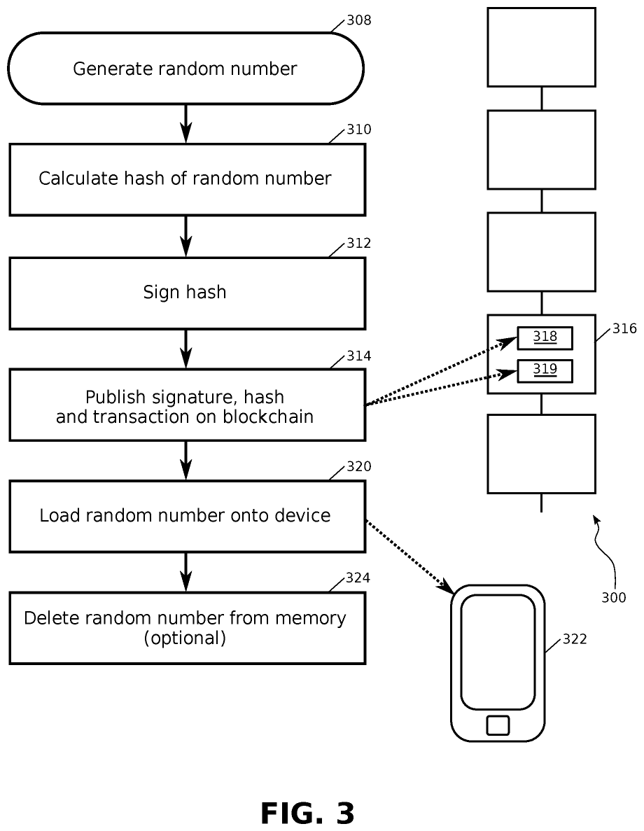

In FIG. 3 a flow diagram illustrating a process for loading a nonce onto a device 322 and publishing a hash of the nonce onto a blockchain 300 with a token transaction 319 is presented, in accordance with an embodiment of the present disclosure.

In the embodiment, actions may commence with a generation of a random number, as illustrated in step 308.

In the embodiment, actions may proceed with a calculation of a hash of the random number, as illustrated in step 310. The hash may be calculated using a cryptographic hash algorithm, for example: SHA, RIPEMD, Whirlpool, Scrypt, HAS-160, BLAKE, or other cryptographic hash function.

In the embodiment, actions may proceed with generating a signature of the hash of the random number, as shown in step 312. The hash may be signed with a digital certificate. A digital signature algorithm used may be one of ECDSA, DSA, RSA, or some other secure asymmetric key digital signing algorithm.

In the embodiment, actions may proceed with publishing the signature, the hash, and the token transaction 319 on the blockchain 300 as shown in step 314. The signature and the hash may be submitted to participants on the blockchain 300 as a transaction 318, and the transaction 318 may be included in a block 316 of the blockchain. The token transaction 319 may be published in the block 316. In some embodiments the token transaction 319 may be published in a later block, or an earlier block.

In the embodiment, actions may proceed with loading the random number onto a device 322, as shown in step 320. The device 322 may comprise an IoT device. In other embodiments the device 322 may comprise a module, a microchip, a silicon die, a silicon wafer.

In the embodiment, actions may proceed with deleting the random number from a memory of an apparatus performing some or all of an aforementioned steps, as shown in step 324.

Those skilled in the art will appreciate that in the embodiment above, for illustrative purposes, a specific example of described actions has been presented. In other examples some of the described actions may be taken in an alternate order, and other actions may be taken.

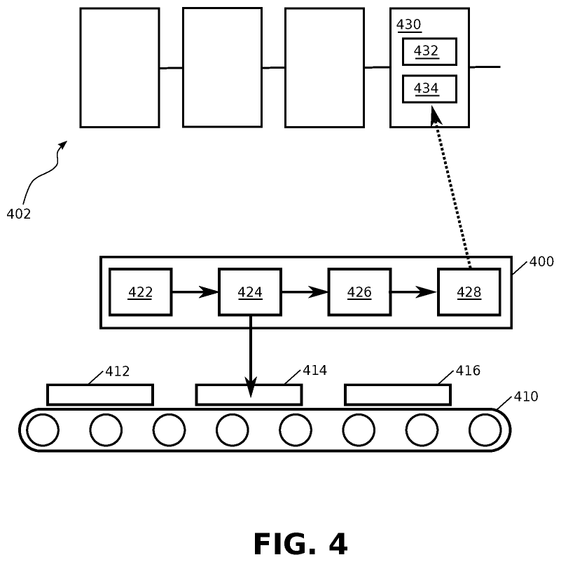

In FIG. 4 an embodiment of an apparatus 400 for loading a nonce onto a device, and publishing a hash of the nonce and an associated token transaction on a blockchain 402, is presented.

In some embodiments, the apparatus 400 may comprise a number of modules, including: a random number generator 422, a data loading module 424, a hash calculator 426, a blockchain messaging module 428.

In some embodiments, the random number generator 422 may generate a random number, henceforth referred to as a nonce, and pass it to the data loading module 424.

In some embodiments, the data loading module 424 may load the nonce onto a device 414, and if loading the nonce is successful, the data loading module 424 may pass the nonce to the hash calculator 426. In other embodiments the random number generator 422 may pass the nonce to the hash calculator 426.

In some embodiments, the hash calculator 426 may calculate a hash of the nonce, and may then pass the hash to the blockchain messaging module 428.

In other embodiments, the hash calculator 426 may derive a public key from the nonce, and may pass the public key to the blockchain messaging module 428. In further other embodiments, the hash calculator 426 may derive a cryptocurrency address from the nonce, and may pass the cryptocurrency address to the blockchain messaging module 428.

In the further other embodiments, the cryptocurrency address may comprise one or more of: a Bitcoin™ address, an Ethereum™ address, and an alternative digital currency address.

In some embodiments, the blockchain messaging module 428 may transmit a message 432 comprising the hash to the blockchain 402 for inclusion in a block 430. In other embodiments the message 432 may comprise an authorized digital certificate, and the hash may be signed using the authorized digital certificate. In further embodiments, the blockchain messaging module 428 may transmit a token transaction 434 associated with the message 432 for inclusion in the block 430 or some other block on the blockchain 402.

In some embodiments, devices 412, 414, 416, may be presented in turn to the apparatus 400, by a conveyance 410, to be loaded with nonces by the data loading module 424. In an example state of the apparatus 400 and associated system, the device 416 may be loaded with a nonce, the device 414 may be undergoing loading with a nonce, and the device 412 may be awaiting loading with a nonce.

In some embodiments, devices 412, 414, 416, may each be loaded with a unique cryptocurrency address. In further embodiments each of the unique cryptocurrency addresses may comprise a cryptocurrency balance or value.

In some embodiments, each of the devices 412, 414, 416 may comprise an IoT device. In other embodiments the devices 412, 414, 416 may comprise one or more of: a module, a microchip, a silicon die, a silicon wafer, an other device to be loaded with a nonce.

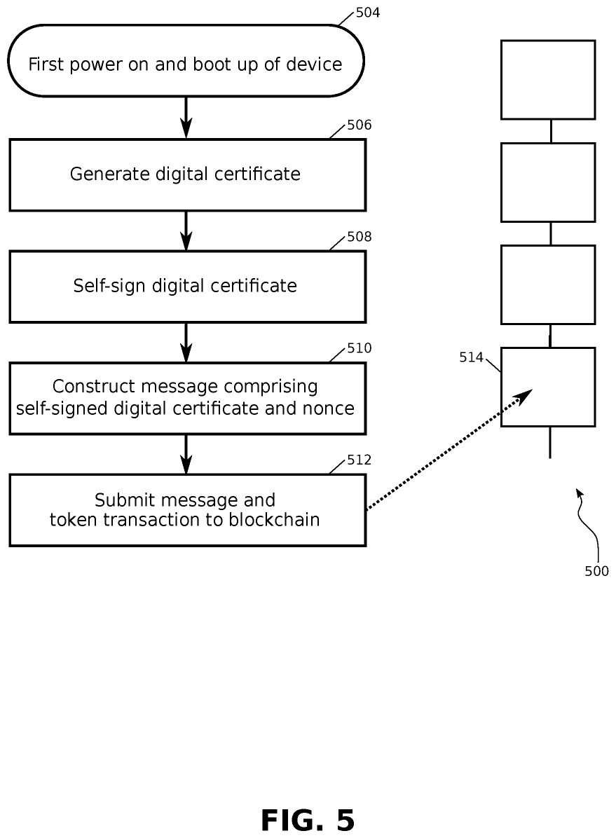

In FIG. 5 a flow diagram is presented, illustrating a process for a device to generate a digital certificate and validate said digital certificate on a blockchain, together with a token transaction.

In some embodiments, actions may commence with a device powering on and booting up for a first time, as illustrated in step 504. In other embodiments actions may commence after a plurality of device powering on events or device booting up events. In yet other embodiments, actions of generating a valid digital certificate may commence after a number of other non-related actions, which may comprise one or more of: a factory reset, a firmware upgrade, and a software patch application.

In some embodiments, actions may proceed with a a generation of a digital certificate, as illustrated in step 506.

In some embodiments, actions may proceed with a self-signing of the digital certificate, as shown in step 508. A digital signature algorithm used may be one of ECDSA, DSA, RSA, or some other secure asymmetric key digital signing algorithm.

In some embodiments, actions may proceed with a construction of a message comprising the digital certificate, a self-signature of the digital certificate, and a nonce, as shown in step 510. In an embodiment of the present disclosure, the nonce may be loaded onto the device at a prior time, stored in secure storage or non-transitory memory within the device, and subsequently retrieved from secure storage or non-transitory memory.

In some embodiments, actions may proceed with a submission of the message for inclusion in a block 514 of the blockchain 500, as shown in step 512. In further embodiments a token transaction may also be transmitted for inclusion in the block 514. The token transaction may comprise one or more of: an offering of tokens, a claiming of a prior offering of tokens, and a generation of tokens.

Those skilled in the art will appreciate that in the embodiments above, for illustrative purposes, specific examples of described actions are presented. In other examples some of the described actions may be taken in an alternate order, and other actions may be taken.

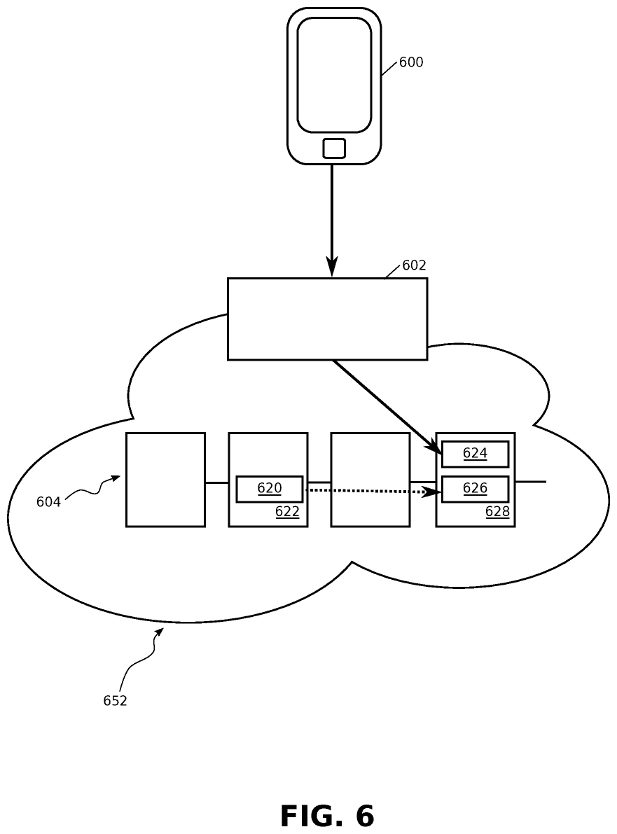

FIG. 6 is a diagram presenting an intermediary 602 publishing an announcement of a digital certificate on behalf of an IoT device 600, which may have intermittent or limited access to the Internet.

In some embodiments, the intermediary 602 may comprise one or more of: a proxy, a blockchain node, a Constrained Application Protocol (CoAP) server, a Message Queuing Telemetry Transport (MQTT) server, and an other server configured to accept messages from the device and forward them on to the blockchain.

In some embodiments, the IoT device 600 may construct a message comprising a pre-loaded nonce and a digital certificate, and may transmit the message to the intermediary 602. In further embodiments, the IoT device 600 may construct a token transaction, and may transmit the token transaction to the intermediary 602.

In some embodiments, the intermediary 602 may forward the transaction on to a blockchain 604, which in further embodiments may be instantiated in a cloud platform 652.

One or more of the message and the token transaction may then be included as message data 620 and transaction data 626 in a block 628 included in the blockchain 604.

In some embodiments, the intermediary 602 may also comprise a blockchain miner, and may construct the block 628 and append said block 628 to the blockchain 604.

In some embodiments, the transaction data 626 may reference a prior token transaction 620 included in a prior block 622. The prior token transaction 620 may comprise an offering of tokens, and the transaction data 626 may comprise a redemption or claiming of tokens.

In other embodiments, the transaction data 626 may comprise an offering of tokens, said tokens being redeemed by an entity on signing a digital certificate contained in the message data 624.

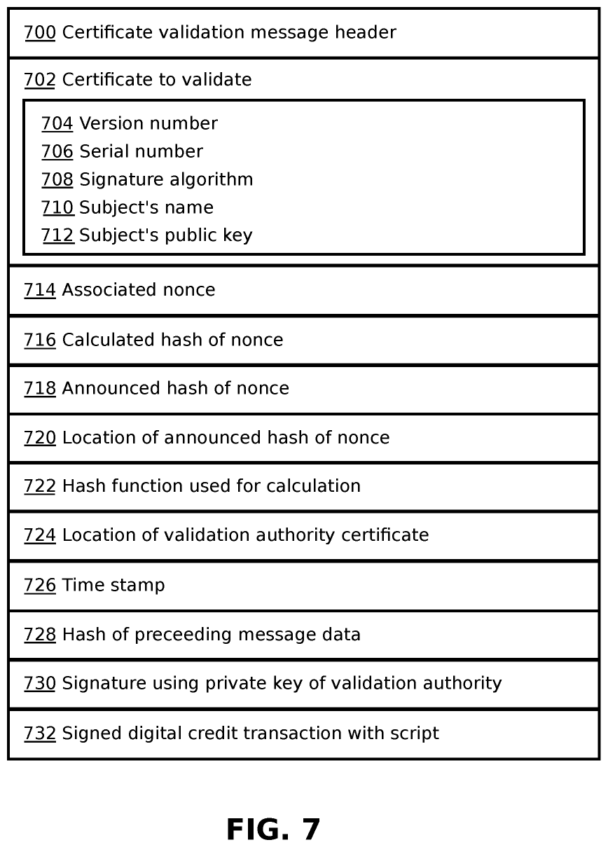

FIG. 7 illustrates a structure for a certificate validation message, published on a blockchain, said certificate validation message verifying an announcement of a digital certificate, publishing a signature for the digital certificate, and claiming tokens through a signed digital credit transaction.

In some embodiments, the certificate validation message may comprise a header 700, which in some embodiments may comprise: an identifier indicating that the message comprises a certificate validation, a size of the message, a protocol for the message, a structure of data included in the message.

The certificate validation message may comprise a certificate data 702, which in some embodiments may comprise a digital certificate previously presented on the blockchain for signing. The certificate data 702 may comprise a version number 704, a serial number 706, an identifier of a signature algorithm 708, a name or identifier of an entity presenting the certificate 710, a public key 712 associated with the certificate or in other embodiments, with the name or identifier of the entity presenting the certificate 710.

The certificate validation message may comprise an associated nonce 714. The associated nonce may comprise an integer or a binary data, loaded onto a device at a prior time. A hash of the nonce may previously have been announced on the blockchain.

The certificate validation message may comprise a calculated hash of the associated nonce 716, said calculation performed using a hash algorithm agreed upon by participants on the blockchain.

The certificate validation message may comprise an announced hash of the associated nonce 718, said announced hash previously published on the blockchain by an apparatus loading the nonce onto a device.

The certificate validation message may comprise a location 720 of the announced hash of the nonce on the blockchain. In some embodiments the location 720 may comprise a sequence number of a block comprising a message, known to those skilled in the art as a block height. In other embodiments the location 720 may comprise one or more of: a time stamp of the block, and a byte offset within a digital representation of the blockchain.

The certificate validation message may comprise an identifier 722 of a hash function used to calculate a hash of the nonce. The hash function may be a cryptographic hash algorithm, for example: SHA, RIPEMD, Whirlpool, Scrypt, HAS-160, or BLAKE, or a combination of some or all of the preceding hash functions.

The certificate validation message may comprise a further location 724 of a validation authority certificate on the blockchain. In some embodiments the further location 724 may comprise one or more of: a time stamp of the block, a byte offset within a digital representation of the blockchain, the block height, and an identifier of a signer. In a further embodiment of this disclosure, the validation authority certificate may comprise one or more of: an authorized digital certificate associated with an apparatus that generated and loaded the nonce onto the device, a root certificate that signed the authorized digital certificate, and a further authorized digital certificate.

The certificate validation message may comprise a time stamp 726. In an embodiment the time stamp 726 may comprise a time at which the certificate validation message was constructed. The certificate validation message may also comprise a plurality of time stamps.

The certificate validation message may comprise a message hash 728 of all or part of a preceding certificate validation message contents. The message hash 728 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The certificate validation message may also comprise a digital signature 730, generated with a digital signature algorithm using a private key associated with the validation authority certificate and the message hash 728, in order to provide for the veracity of the certificate validation message. The digital signature algorithm used may be one of ECDSA, DSA, RSA, or some other secure asymmetric key digital signing algorithm.

The certificate validation message may comprise a signed digital credit transaction 732. The signed digital credit transaction 732 may comprise a script, said script providing validation for a token transaction. In some embodiments the signed digital credit transaction 732 may comprise a claiming of previously offered tokens, and may be validated through an action of signing the certificate data 702. In other embodiments the signed digital credit transaction 732 may comprise a smart contract.

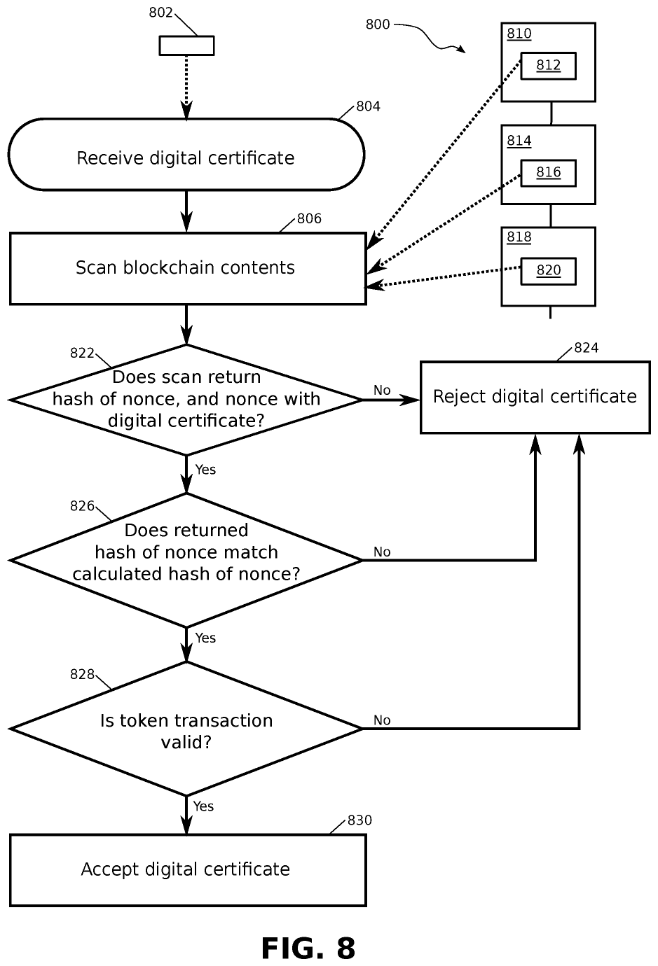

In FIG. 8 a flow diagram illustrating a third party verifying, through a medium of a blockchain 800, a validity of a digital certificate 802 presented by a device, is shown.

In an embodiment, the validity of the digital certificate 802 may depend on one or more of: a valid structure of the digital certificate 802, a valid signing of the digital certificate 802 by an authorizing certificate, and a valid token transaction corresponding to a payment for the digital certificate 802.

In an embodiment, operations may commence through a receiving of the digital certificate 802, as shown in step 804. The digital certificate 802 may be received as part of an initiation of a secure communication channel, for example: an SSL connection, a TLS connection, a DTLS connection, or an other form of secure communication channel.

The blockchain 800 may then be scanned for transactions referencing the digital certificate 802, as shown in step 806. In a present example of the embodiment, a transaction 812 comprising the digital certificate 802 and a nonce may be detected in a block 810 of the blockchain 800, an announcement transaction 816 comprising a hash of the nonce may be detected in a block 814, and a token transaction 820 comprising a payment for the digital certificate 802 may be detected in a block 818. In other embodiments different transactions may or may not be detected in different blocks.

In step 822 results of a scan of the blockchain may be examined. If the scan does not return a copy of the digital certificate 802, the nonce, and the hash of the nonce, operations may proceed to step 824, and the digital certificate 802 may be rejected. In some embodiments, the initiation of the secure communication channel may therefore be terminated.

If the scan does return the copy of the digital certificate 802, the nonce, and the hash of the nonce, operations may proceed to step 826.

In step 826 the hash of the nonce may be compared with a calculated hash of the nonce. If the hash of the nonce and the calculated hash of the nonce are not equal, operations may proceed to step 824, and the digital certificate 802 may be rejected. In some embodiments, the initiation of the secure communication channel may therefore be terminated.

If the hash of the nonce and the calculated hash of the nonce are equal, operations may proceed to step 828.

In step 828 the token transaction 820 may be examined. If the token transaction is determined to be invalid, operations may proceed to step 824, and the digital certificate 802 may be rejected. In some embodiments, the initiation of the secure communication channel may therefore be terminated.

In some embodiments the token transaction 820 may comprise a smart contract. Said smart contract, when run, may return a true or false result for determining the validity of the token transaction 820.

If the token transaction 820 is determined to be valid, operations may proceed to step 830.

In step 830, the digital certificate may be accepted as valid, and the initiation of the secure communication channel may be successfully completed.

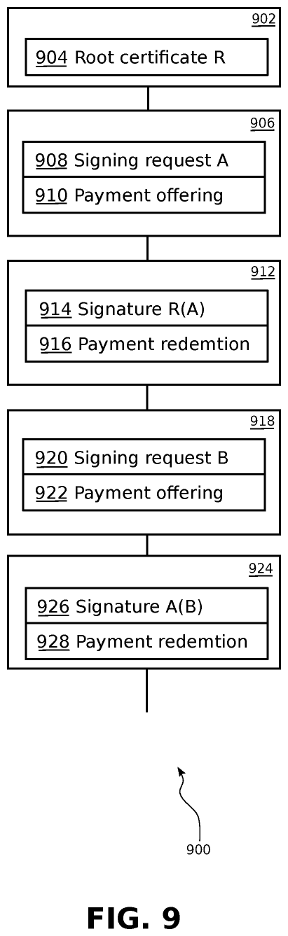

In FIG. 9 an illustration of a chain of digital certificates and authorization signatures on a blockchain 900 is presented. A validity of a digital certificate may depend on said digital certificate being signed by an authorized certificate. Those skilled in the art will be aware that authority may be chained through a list of signed certificates, leading back to an initial root certificate. Through a blockchain the list may be stored and accessed in a decentralized manner, without need for recourse to a central authority.

In some embodiments, the validity of the digital certificate may depend on one or more token transactions comprising a payment offering and a payment redemption.

In an embodiment, a block 902 may comprise a certificate announcement message 904, said certificate announcement message comprising a root certificate R.

A subsequent block 906 may comprise a signing request 908 for a certificate A. In some embodiments, certificate A may comprise an authorized digital certificate of an apparatus for provisioning a device with a digital certificate. In further embodiments, the signing request 908 may be associated with a payment offering 910, for example through a token transaction.

A further block 912 may comprise a signature message 914, said signature message 914 comprising a signature R(A), wherein certificate A may be signed by root certificate R, thereby providing certificate A with an authority to sign and validate subsequent digital certificates. The signature message 914 may be associated with a payment redemption 916, for example through a token transaction.

In some embodiments the payment redemption 916 may claim a part or all of of the payment offering 910.

An other further block 918 may comprise a further signing request 920 for a certificate B. In some embodiments, certificate B may comprise a digital certificate for the device. The signing request 920 may consist of a transaction comprising a nonce provided to the device by the apparatus, and a self-signed digital certificate provided by the device. In further embodiments, the signing request 920 may be associated with a payment offering 922, for example through a token transaction.

An other subsequent block 924 may comprise a further signature message 926, said further signature message 926 comprising a signature A(B), wherein certificate B may be signed by certificate A. The signature message 926 may be associated with a payment redemption 928, for example through a token transaction.

Those skilled in the art will appreciate from the above disclosure that the blockchain 900 comprises a sequence of certificates, signing requests and signatures, whereby a chain of authorization extends from root certificate R to a certificate B, with associated token transactions offering and redeeming payment through a digital currency, cryptocurrency or distributed ledger token. In general, the method may be extended to include a longer chain, a tree, a web, or a tangle of interdependent signed certificates.

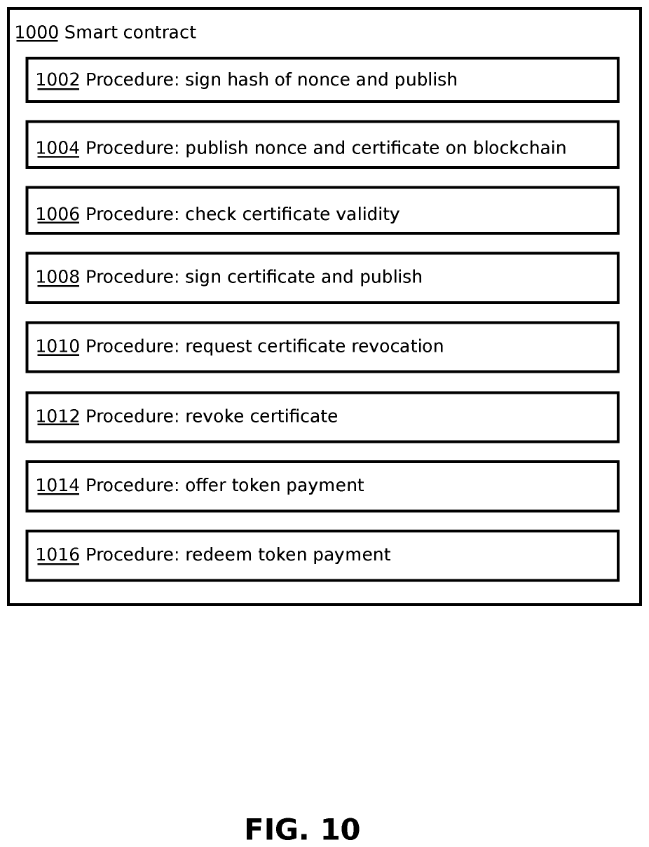

In FIG. 10 an exemplary embodiment of a structure of a smart contract 1000 is presented. In the exemplary embodiment the smart contract 1000 may provide blockchain functionality in a form of procedures and methods related to digital certificate provisioning and associated offerings and redemptions of payment through tokens.

In some embodiments the smart contract 1000 may comprise a procedure 1002 for signing a hash of a nonce and publishing the hash on a blockchain.

In some embodiments the smart contract 1000 may comprise a procedure 1004 for publishing a nonce and a digital certificate on the blockchain.

In some embodiments the smart contract 1000 may comprise a procedure 1006 for checking a validity of a digital certificate. Said procedure 1006 may take a digital certificate as an input parameter, scan the blockchain for an associated hash of a nonce, and a transaction comprising a copy of the digital certificate and the nonce, and may subsequently determine the digital certificate to be valid. In some embodiments the procedure 1006 may further determine a validity of associated token transactions.

In some embodiments the smart contract 1000 may comprise a procedure 1008 for generating a signature for a digital certificate and publishing the signature on the blockchain.

In some embodiments the smart contract 1000 may comprise a procedure 1010 generating a revocation request for a digital certificate and publishing it on the blockchain, when called with appropriate parameters. The appropriate parameters may comprise one or more of: a request to revoke, a certificate identifier, a digital signature authorizing a revocation, and a payment offering.

In some embodiments the smart contract 1000 may comprise a procedure 1012 revoking a certificate when called with appropriate parameters. The appropriate parameters may compromise one or more of: a reference to request to revoke, a certificate identifier for a certificate to revoke, a digital signature authorizing a revocation, and a payment acceptance.

In some embodiments the smart contract 1000 may comprise a procedure 1014 generating a token payment offering transaction, and publishing it on the blockchain.

In some embodiments the smart contract 1000 may comprise a procedure 1016 generating a token payment redemption transaction, and publishing it on the blockchain.

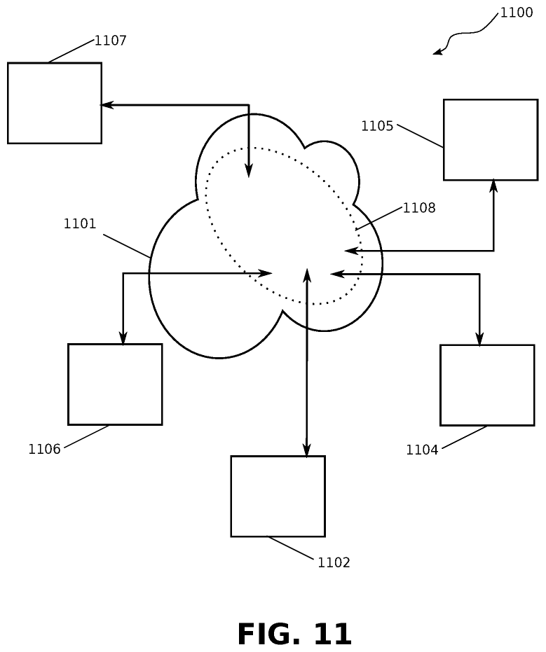

The systems and methods disclosed above may be embodied in a system of a plurality of network connected devices communicating through the medium of a peer-to-peer network system 1100 instantiating and maintaining a blockchain, as shown schematically in FIG. 11.

As depicted, the peer-to-peer network 1108 may be embodied within a packet switched network 1101, through an interconnection of the plurality of network connected devices on the peer-to-peer network 1108.

A device 1102 may connect to the peer-to-peer network 1108 as a digital certificate provisioning apparatus. Said device 1102 may submit a transaction comprising a hash of a nonce to the peer-to-peer network for inclusion on the blockchain, and may load the nonce onto a device 1107.

Other devices connected the peer-to-peer network may include a network connected device acting as a node 1104, whose role is to maintain a list of other devices connected through the peer-to-peer network, and to forward on received network messages to those devices on the list, possibly independently, or possibly as a response to a request from another network connected device. As one skilled in the art will be aware, no individual node is required to have a complete list of all devices, as the process of peer-to-peer networking only requires that a union of a set of all nodes contains a complete list of all devices on the peer-to-peer network, and for every pair of network connected devices there is a network route from one device to the other, possibly via a set of one or more nodes. Therefore, the only requirement to be a participant on the peer-to-peer network is to establish a connection to one or more of the nodes on said network.

Further devices connected via the peer-to-peer network may include one or more network connected devices 1105, 1106 acting as a miner, whose role is to receive or request certificate signing and certificate revocation messages from the peer-to-peer network, process them according to a protocol of the blockchain, and transmit results of said processing back to the peer-to-peer network for inclusion in the blockchain.

The device 1107 may connect to the peer-to-peer network as a client, and may submit a transaction comprising a digital certificate and the nonce, or other transactions as disclosed above.

In some embodiments of the technology described herein, the nonce may comprise a symmetric key, and the hash of the nonce may comprise a known plaintext signed by the the symmetric key.

In other embodiments of the present disclosure, the nonce may comprise an asymmetric key, and the hash of the nonce may comprise a public key of the asymmetric key. In some embodiments the hash of the nonce may comprise a hash of the public key of the asymmetric key, or a combination of transformations and applications of one or more hash functions to the public key of the asymmetric key.

In other embodiments of the present disclosure, the nonce may comprise binary data obtained through a proof of work effort, such that, when said binary data is hashed a predetermined number of times, an output is generated with a predefined property. The predefined property may comprise: having a value lower than a predetermined target value, having a value higher than a predetermined target value, and being a prime number larger than a predetermined target value.

In other embodiments, the nonce may be hashed repeatedly to generate a one-time pad. For example, and without loss of generality, the nonce may be hashed ten times to generate a list of ten hash values. Initially a tenth hash may be published on the blockchain. Subsequently, the device may publish a ninth hash on the blockchain when presenting a certificate for signing, said ninth hash producing the tenth hash when hashed. The device may then revoke the certificate at a later date, and publish an eighth hash on the blockchain when presenting a new certificate for signing, said eighth hash producing the ninth hash when hashed. Those skilled in the art will appreciate that this process may be repeated, allowing for multiple certificate signing over time using the one-time pad.

The technology described herein is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic-link library.

The system may be used in connection with various operating systems such as Linux®, UNIX® or Microsoft Windows®.

The system may be written in any conventional programming language such as C, C++, Pascal, or Java, and run under a conventional operating system. C, C++, Pascal, Java, and FORTRAN are industry standard programming languages for which many commercial compilers can be used to create executable code. The system may also be written using interpreted languages such as Perl, Python or Ruby, or languages that may either be compiled or interpreted, such as BASIC or Lisp.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, micro-controller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

As will be appreciated from the above discussion, an advantage of the systems and methods of this disclosure includes provisioning a device with a digital certificate with associated payment for said provisioning, without recourse to a central authority, through the medium of a blockchain.

What is claimed is:

1. A method for enabling a payment for provisioning a device with a digital certificate, comprising:
loading a nonce onto the device;
publishing a message, comprising a hash of the nonce signed by an authorized digital certificate, on a blockchain; and
publishing a second message, comprising: the digital certificate, the nonce, and a token transaction, on the blockchain.

2. The method of claim 1, wherein the message further comprises an offering of a token, and the token transaction comprises a claim of the token.

3. The method of claim 1, wherein the token transaction comprises an offering of a token.

4. The method of claim 3, further comprising publishing, on the blockchain, a third message comprising: a signature of the digital certificate generated using a second authorized digital certificate, and a second token transaction comprising a claim of the token.

5. The method of claim 1, wherein the device is an Internet of Things (IoT) compatible device.

6. The method of claim 1, wherein the token transaction is stored and executed using a smart contract on the blockchain.

7. The method of claim 4, wherein one or more of the token transaction and the second token transaction are stored and executed using a smart contract on the blockchain.

8. An apparatus enabling a payment for provisioning a device with a digital certificate, wherein the apparatus comprises a processor configured to:
load a nonce onto the device; and
publish, on a blockchain, a message comprising a hash of the nonce signed by an authorized digital certificate;
and wherein the device is configured to:
publish, on the blockchain, a second message comprising: the digital certificate, the nonce, and a token transaction.

9. The apparatus of claim 8, wherein the message further comprises an offering of a token, and the token transaction comprises a claim of the token.

10. The apparatus of claim 8, wherein the token transaction comprises an offering of a token.

11. The apparatus of claim 10, wherein the processor is further configured to publish, on the blockchain, a third message comprising: a signature of the digital certificate generated using a second authorized digital certificate, and a second token transaction comprising a claim of the token.

12. The apparatus of claim 8, wherein the device is an Internet of Things (IoT) compatible device.

13. The apparatus of claim 8, wherein the token transaction is stored and executed using a smart contract on the blockchain.

14. The apparatus of claim 11, wherein one or more of the token transaction and the second token transaction are stored and executed using a smart contract on the blockchain.

15. A non-transitory computer readable medium embodying instructions for enabling payment for provisioning a device with a digital certificate, the instructions when executed causing a processor to perform:
loading a nonce onto the device; and
publishing, on a blockchain, a message comprising a hash of the nonce signed by an authorized digital certificate;
and wherein the device is configured to:
publish, on the blockchain, a second message comprising: the digital certificate, the nonce, and a token transaction.

16. The non-transitory computer readable medium of claim 15, wherein the message further comprises an offering of a token, and the token transaction comprises a claim of the token.

17. The non-transitory computer readable medium of claim 15, wherein the token transaction comprises an offering of a token.

18. The non-transitory computer readable medium of claim 17, wherein the processor is further configured to perform publishing, on the blockchain, a third message comprising: a signature of the digital certificate generated using a second authorized digital certificate, and a second token transaction comprising a claim of the token.

19. The non-transitory computer readable medium of claim 15, wherein the device is an Internet of Things (IoT) compatible device.

20. The non-transitory computer readable medium of claim 15, wherein the token transaction is stored and executed using a smart contract on the blockchain.

21. The non-transitory computer readable medium of claim 18, wherein one or more of the token transaction and the second token transaction are stored and executed using a smart contract on the blockchain.
